(19) United States
(12) Patent Application Publication
(10) Pub. No.: US 2006/0217642 A1
(43) Pub. Date: Sep. 28, 2006

(54) Massage machine

(76) Inventors: Takayoshi Tanizawa, Osaka (JP); Masamichi Miyaguchi, Osaka (JP); Fumihiro Nishio, Osaka (JP); Daisuke Tsukada, Osaka (JP); Yuichi Nishibori, Osaka (JP); Motoharu Muto, Osaka (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/553,735

(22) PCT Filed: Apr. 21, 2004
(86) PCT No.: PCT/JP04/05755

§ 371 Date: Oct. 20, 2005

(30) Foreign Application Priority Data
Apr. 22, 2003 (JP) 2003-117602

(51) Int. Cl. A61H 7/00

(52) U.S. Cl. 601/98; 601/100; 601/101

(57) ABSTRACT

This massage machine is a chair type massage machine and comprises a body 1, and an input device 2 for inputting various instructions to the body 1. The body 1 has a massage unit 10 and a controller 11 for controlling the massage unit 10. The controller 11 comprises a MPU 100 and a memory 101, and is electrically connected to the input device 2 and the massage unit 10. The memory 101 comprises a EEPROM 101A, which is a nonvolatile memory and stores massage programs for controlling the massage unit 10 and other mechanisms (not shown), and a RAM 101B, which is a volatile memory and temporarily stores a change of a parameter of the massage program inputted from the input device 2 during the execution of the massage program. The change of the parameter stored in the RAM 101B is written into the EEPROM 101A upon completion of a massage course, and the EEPROM 101A stores the change of the parameter while making it correspond to the each user registered by the input device 2.

### TECHNICAL FIELD

The present invention relates to a massage machine and, more particularly, to a massage machine which gives a massage to a user according to a massage program.

### BACKGROUND ART

Japanese Non-examined. Patent Publication No.7-323066 discloses a conventional massage machine. In this massage machine, a type of massage, an operating range of massage, an iteration count of massage, etc. are controlled by a massage program. This massage machine is equipped with an input device, by which a user can change the massage program so as to tailor the massage program to his or her taste. This massage machine is further equipped with a memory, which can store a set of parameter changes of the massage program. Therefore, a user can easily get a massage which suits his or her taste by calling up the stored parameter changes, without changing parameters every time he or she uses the massage machine.

However, the above massage machine can store only one set of parameter changes. So, when two or more people use the massage machine in a home and so on, although one person can easily get a massage which suits his or her taste, remaining people have to change the parameters every time he or she uses the massage machine so as to get a massage which suits his or her taste.

### DISCLOSURE OF THE INVENTION

In view of the above problem, the object of the present invention is to provide a massage machine which can give each of users a massage which suits his or her taste without troublesome operation.

The massage machine in accordance with the present invention is a massage machine which gives a massage to a user according to a massage program, and it includes a parameter changing means for inputting a change of a parameter of the massage program, a memory for storing the change of the parameter inputted by the parameter changing means for each user, a user discrimination means for discriminating each user out of two or more users stored in the memory, and a control means which reads out the change of the parameter corresponding to the user discriminated by the user discrimination means from the memory and executes the massage program according to the change of the parameter.

Therefore, because this massage machine stores a change of a parameter of the massage program inputted by the parameter changing means for each user in the memory, and executes the massage program according to the change of the parameter corresponding to a user discriminated by the user discrimination means by the control means, each user can get a massage which suits his or her taste without changing a parameter every time he or she uses the massage machine.

Preferably, the memory comprises a first memory for temporarily storing the change of the parameter inputted by the parameter changing means during execution of the massage program for a user, and a second memory for storing the change of the parameter stored in the first memory while making the change correspond to the user after completion of the massage program. In this case, because a change of a parameter made by a user during the execution of the massage program is memorized while being made to correspond to the user, each user can store a massage program which suits his or her taste in the massage machine by adjusting the parameter while using the massage machine.

Preferably, the massage machine is a chair type massage machine which has a backrest having a built-in massage unit which gives a massage movement to a user, and the parameter of the massage program includes a massage unit position parameter concerning a position of the massage unit, and the memory stores a change of the massage unit position parameter inputted by the parameter changing means for each user, and the control means reads out the massage unit position parameter corresponding to a user discriminated by the user discrimination means from the memory and executes the massage program according to the massage unit position parameter. In this case, a user can get a massage in a condition where the massage unit was disposed in a place which suits his or her taste, without changing the position of the massage unit.

Preferably, the massage machine is a chair type massage machine which has a backrest having a built-in massage unit which provides a massage movement to a user, and the parameter of the massage program includes an angle parameter concerning a reclining angle of the backrest, and the memory stores a change of the angle parameter inputted by the parameter changing means for each user, and the control means reads out the angle parameter corresponding to a user discriminated by the user discrimination means form the memory, and decides the reclining angle according to the angle parameter and executes the massage program. In this case, a user can get a massage in a condition where the reclining angle was adjusted to suit his or her taste, without changing the reclining angle.

Preferably, the user discrimination means discriminates each user by at least one of a fingerprint and voice. In this case, the user discrimination means can discriminate individual user reliably out of two or more users. Also, the user discrimination means can discriminate many users easily.

### BRIEF DESCRIPTION OF THE DRAWINGS

FIG. 1 is an outside drawing of a massage machine in accordance with a first embodiment of the present invention.

FIG. 2 is a block diagram of the massage machine.

FIG. 3 is plan view of an input device of the massage machine.

FIG. 4 is a view for explaining a memory of the massage machine.

FIG. 5 is a plan view of an input device of a massage machine in accordance with a second embodiment of the present invention.

FIG. 6 is an outside drawing of a massage machine in accordance with a first embodiment of the present invention.

FIG. 7 is a block diagram of the massage machine of FIG. 6.

### BEST MODE FOR CARRYING OUT THE INVENTION

Hereinafter, the present invention will be described in more detail with reference to the accompanying drawings.

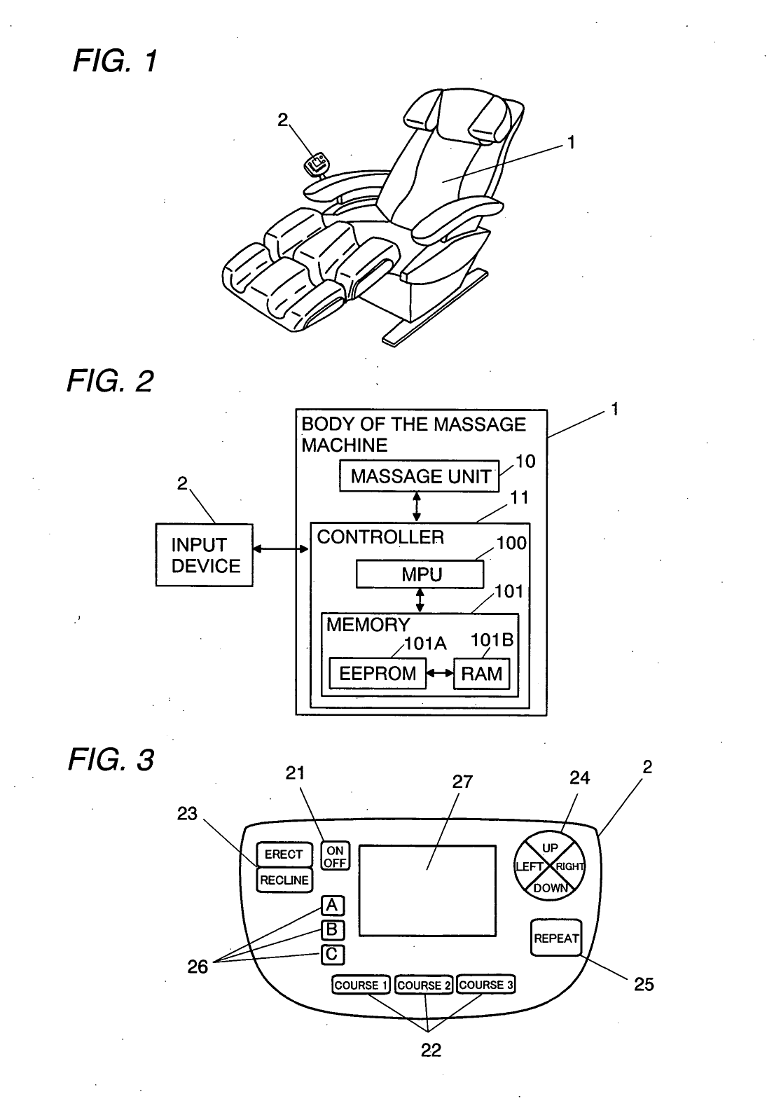

FIG. 1 shows a massage machine in accordance with a first embodiment of the present invention. This massage machine is a chair type massage machine and comprises a body 1, and an input device 2 for inputting various instructions to the body 1.

The body 1 has a built-in massage unit 10 which gives a user a massage movement, and a controller 11 for controlling the massage unit 10. The controller 11 comprises a MPU 100 (control means) and a memory 101, and is electrically connected to the input device 2 and the massage unit 10. As described in detail later, the memory 101 comprises a EEPROM 101A (a second memory), which is a nonvolatile memory and stores massage programs for controlling the massage unit 10 and other mechanisms (not shown), and a RAM 101B (a first memory), which is a volatile memory and temporarily stores a change of a parameter of the massage program inputted by the input device 2 during execution of the massage program. The change of the parameter stored in the RAM 101B is written into the EEPROM 101A upon completion of a massage course, and the EEPROM 101A stores the change of the parameter while making it correspond to the user who made the change.

As shown in FIG. 3, the input device 2 is equipped with a switch 21 for turning on/off the body 1, course selection keys 22 for selecting one massage course out of a plurality of massage courses (three courses in this embodiment) configured in advance, parameter changing keys (parameter changing means) 23 to 25 for inputting various changes into the massage course selected by the course selection keys 22 during the execution of the massage course, user discrimination keys 26 (user discrimination means) for registering a plurality of users (up to three users in this embodiment) in the memory 101 and for discriminating each user out of the users registered in the memory 101, and a display 27 for displaying various information, such as a selected massage course, a position of the massage unit 10, etc..

Hereinafter, each part of the massage machine will be described in more detail along a procedure for using the massage machine.

When the memory 101 is in an initial state where it has no user registration information, a user turns on the switch 21 to activate the body 1 and selects one of the massage courses, for example a “course 1”, from the course selection keys 22. Then, the MPU 100 reads out, from the EEPROM 101A, a massage program corresponding to the “course 1” and executes the massage program. Thereby, the massage is started, and the massage unit 10 is controlled according to the massage program.

During the execution of the massage program, the user can change various motions of the massage course by the input device 2 so as to tailor the massage motion to his or her taste.

For example, when the user wants to change the reclining angle set up automatically by the massage program, the user pushes reclining keys 23. Then, a parameter concerning the reclining angle (namely, an angle parameter) in the executed massage program is changed, and the controller 11 controls a reclining mechanism (not shown) according to the change of the reclining angle, whereby the reclining angle is changed. The change of the angle parameter made at this time is stored in the RAM 101B.

Or, when the user wants to fine-tune the position of the massage unit during the execution of the massage, the user pushes position changing keys 24. Then, a parameter concerning the position of the massage unit (namely, a massage unit position parameter) in the executed massage program is changed, and the controller 11 controls the position of the massage unit 10 according to the change of the massage unit position parameter, whereby the position of the massage unit 10 is changed. The change of the position parameter made at this time is stored in the RAM 101B.

In a similar way, when the user wants to repeat a current massage motion, the user pushes a repeat key 25. Then, the current massage motion is repeated, and the change of a parameter concerning the number of the repetition of the massage motion is stored in the RAM 101B.

As described above, changes of parameters of the massage program inputted by the parameter changing keys 23 to 25 during the execution of the massage program are stored in the RAM 101B.

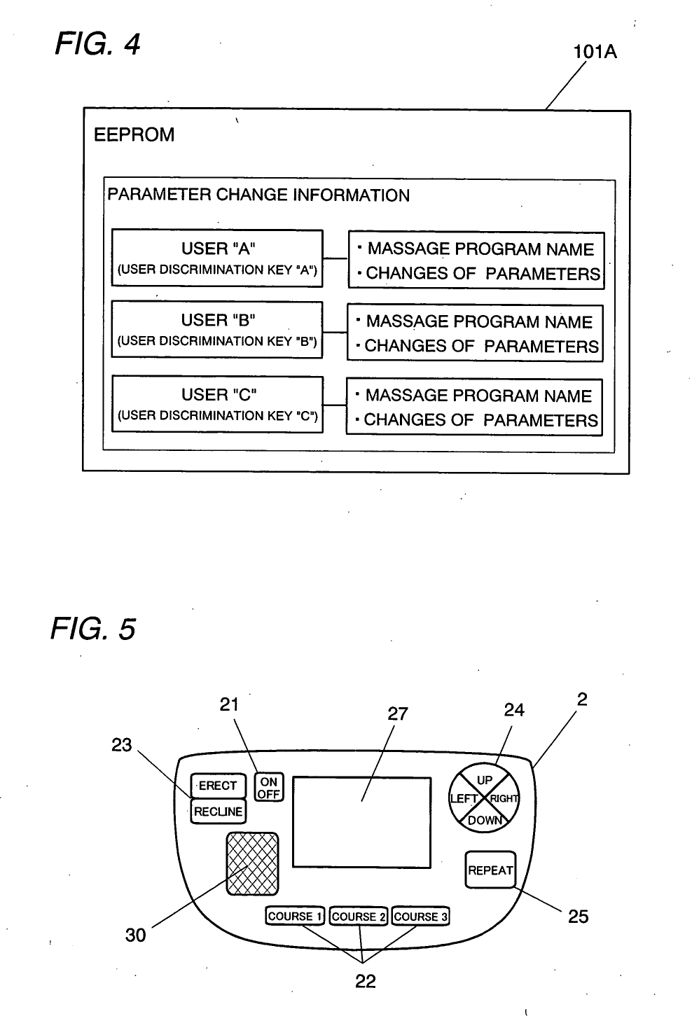

Upon completion of the massage course, the controller 11 moves to a user registration mode. When the user pushes one of the user discrimination keys 26, for example a “A” key, in the user registration mode, the executed massage program name and the changes of the parameters stored in the RAM 101B are written into the EEPROM 101A while being made to correspond to the “A” key. That is, as shown in FIG. 4, the EEPROM 101A memorizes the executed massage program name and the changes of the parameters of the massage program, as parameter change information, while making them correspond to the user who pushed the “A” key (in FIG. 4, referred to as a user “A”) of the user discrimination keys 26.

After that, when the user uses the massage machine, he or she just pushes the “A” key of the user discrimination keys 26 which he or she pushed last time, after activating the massage machine. Then, the MPU 100 reads out the massage program and the changes of the parameters corresponding to the user “A” from the EEPROM 101A and executes the massage program according to the changes of the parameters. Therefore, the user “A” can get a massage of which the reclining angle, the position of the massage unit, and the number of the repetition of the massage motion, etc. suit his or her taste, without changing the parameters again.

Because the changes made by the input device 2 during the execution of the massage are stored in the RAM 101B every time, the user can progress the massage program so that it suits his or her taste more by changing the parameters every time he or she uses the massage machine and overwriting the changes in the EEPROM 101A.

When another user first uses the massage machine, he or she selects one of the massage courses to start the massage, and changes the parameters by the parameter changing keys during the execution of the massage program, and pushes another key of the user discrimination keys, for example a “B” key, in the user registration mode, as with the above-mentioned procedure. As a result, as shown in FIG. 4, the executed massage program name and the changes of the parameters are stored in the EEPROM 101A while being made to correspond to the user who pushed the key “B” (In FIG. 4, referred to as a user “B”) of the user discrimination keys 26.

After that, the user can get a massage which suits his or her taste just by pushing the “B” key of the user discrimination keys, without changing the parameter.

In a similar fashion, still another user can store the changes of the parameters into the EEPROM 101A while making them correspond to a user “C” who pushed a “C” key of the user discrimination keys.

As mentioned above, because this massage machine can store the changes of the parameters of the massage program in the EEPROM 101A for a user who pushed one of the user discrimination keys 26, and the controller 11 executes the massage program according to the changes of the parameters corresponding to a user identified by the user discrimination keys 26, each user can get a massage which suits his or her taste by just pushing one of the user discrimination keys 26, after he or she once registered the changes of the parameters.

In this embodiment, although there are only three kinds of the parameter changing keys: the reclining keys, the position changing keys, and the repeat key, for the sake of easy understanding, the parameter changing keys are not limited to these kinds, but may include, for example, a strength parameter key concerning strength of the massage motion and/or a tempo parameter key concerning tempo of the massage motion.

Although, in General, positions of the user's shoulders are detected by pressure sensors etc. at the onset of the massage course and the massage program is executed with reference to the positions, a user may fine-tune the detected positions of the user's shoulders by the position changing keys 24 so that the detected positions will agree with the positions of the user's shoulders more. Or, a user may set the positions of the shoulders using only the position change keys 24 without using the pressure sensors. Of course, in this case too, the change of the massage unit position parameter concerning the position of the user's shoulders is memorized, and in the next and subsequent execution of the massage, the user does not need to adjust the positions of the shoulders.

FIG. 5 shows an input device in accordance with a second embodiment of the present invention. The basic composition of this embodiment is identical to the first embodiment, so the similar part of these embodiments are identified by the same reference character and no duplicate explanation is made here.

This input device 3 has a fingerprint recognition equipment 30 as a substitute for the user discrimination keys 26 of the input device 2 of the first embodiment. The fingerprint recognition equipment 30 can register a plurality of users in the memory 101 while making them correspond to a fingerprint of each user, and can discriminate each user registered in the memory 101 by the fingerprint.

Concretely speaking, when a user touches the fingerprint recognition equipment 30 at his or her finger tips in the above-mentioned registration mode, the fingerprint recognition equipment 30 stores the executed massage program and the changes of the parameters in the EEPROM 101A while making them correspond to the detected fingerprint.

After that, when the same user uses the massage machine, he or she just touches the fingerprint recognition equipment 30. Then, the MPU 100 reads out the massage program and the changes of the parameters corresponding to the detected fingerprint from the EEPROM 101A and executes the massage program according to the changes of the parameters. Therefore, the user can get a massage of which the reclining angle, the position of the massage unit, and the number of the repetition of the massage motion, etc. suit his or her taste, without changing the parameters.

Although the number of the users whom the machine can discriminate was restricted by the number of the user discrimination keys 26 in the first embodiment, the massage machine of this embodiment can discriminate a lot of users by using the fingerprint recognition equipment 30 without being restricted physically by the number of the keys. Furthermore, there is no fear that a user forgets a user discrimination key in which he or she was registered.

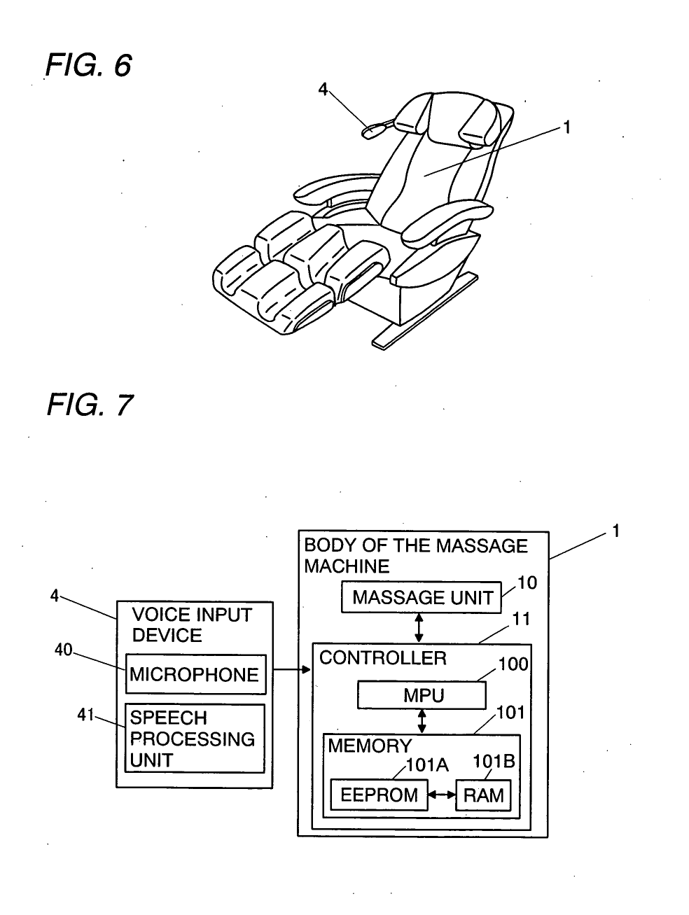

FIG. 6 shows a massage machine in accordance with a third embodiment of the present invention. The basic composition of this embodiment is identical to the first embodiment, so the similar part of these embodiments are identified by the same reference character and no duplicate explanation is made here.

The massage machine has a voice input device 4 as a substitute for the input device 2 of the first embodiment. As shown in FIG. 7, the voice input device 4 comprises a microphone 40 and a speech processing unit 41. The microphone 40 is disposed near a mouth of a user who sat on the massage machine. The speech processing unit 41 has a function to analyze a content of voice-inputted from the microphone 40. For example, when a user said, “Start”, to the microphone 40, the speech processing unit 41 analyzes the content of the voice, “Start”, and gives the MPU 100 an instruction to turn on the body 1. In a similar way, the speech processing unit 41 can analyze a content of voice concerning a course selection and a change of a parameter (for example, a change of the reclining angle, a change of the position of the massage unit, and a change of the number of the repetitions of the massage motion), and can give the MPU 100 an instruction according to the analyzed content.

Furthermore, the speech processing unit 41 has a function to discriminate a user by a voiceprint of voice inputted from the microphone 40. For example, when a user says, “Start”, the speech processing unit 41 can discriminate the user by analyzing the voiceprint of the voice, “Start”.

Hereinafter, this embodiment will be described in more detail along a procedure for using the massage machine.

When a user says, “Start”, to the microphone 40, the speech processing unit 41 analyzes a content of the voice, “Start”, and gives the MPU 100 an instruction to turn on the body 1. Further, the speech processing unit 41 analyzes a voiceprint of the voice, “Start”, and discriminates the user.

If the user having the analyzed voiceprint is not registered, the massage course is begun by a voice, for example, “Course 1”. When the user says, for example, “Repeat”, during the execution of the massage program, the speech processing unit 41 analyzes a content of the voice “Repeat” and gives the MPU 100 an instruction to repeat a current massage motion. As a result, the current massage motion is repeated, and the change of the parameter concerning the number of the repetition of the massage motion is stored in the RAM 101B.

When the massage course is complete, the executed massage program name and the changes of the parameters stored in the RAM 101B are stored in the EEPROM 101A, while being made to correspond to the user having the analyzed voiceprint.

After that, when the user says, “Start”, the speech processing unit 41 discriminates the user by the voiceprint of the voice, “Start”, and the MPU 100 reads out the massage program and the changes of the parameters corresponding to the user from the EEPROM 101A and executes the massage program according to the changes of the parameters. Therefore, the user can get a massage of which the reclining angle, the position of the massage unit, and the number of the repetition of the massage motion suit his or her taste, without changing the parameters.

By using the voice input device 4, the massage machine can discriminate a lot of users without being restricted physically by the number of the keys, as is the case with the second embodiment. Because there is no need to move hand for inputting instructions, operation becomes easier. Furthermore, because a user can operate the massage machine with the backrest reclined, it is more comfortable.

Although the massage machine of this embodiment has only the voice input device 4, the massage machine may have both the voice input device 4 and the input device 3 of the second embodiment. In this case, the user can use either device which is easy to use according to his or her posture. In order to discriminate a user more certainly, both the fingerprint recognition equipment 30 and the voice input device 4 may be used together.

As mentioned above, as many apparently widely different embodiments of this invention may be made without departing from the spirit and scope thereof, K is to be understood that the invention is not limited to the specific embodiments thereof except as defined in the appended claims.

1. A massage machine which gives a massage to a user according to a massage program, said massage machine including:
a parameter changing means for inputting a change of a parameter of the massage program;
a memory for storing said change of the parameter inputted by said parameter changing means for each user;
a user discrimination means for discriminating each user out of two or more users stored in said memory;
a control means which reads out the change of the parameter corresponding to a user discriminated by said user discrimination means from said memory and executes the massage program according to the change of the parameter.

2. The massage machine as set forth in claim 1, wherein said memory comprises a first memory for temporarily storing the change of the parameter inputted by said parameter changing means during execution of the massage program for a user, and a second memory for storing the change of the parameter stored in said first memory while making the change correspond to the user after completion of the massage program.

3. The massage machine as set forth in claim 1, wherein said massage machine is a chair type massage machine which has a backrest having a built-in massage unit which gives a massage movement to a user.

4. The massage machine as set forth in claim 3, wherein the parameter of the massage program includes a massage unit position parameter concerning a position of the massage unit, said memory storing a change of the massage unit position parameter inputted by said parameter changing means for each user, said control means reading out the massage unit position parameter corresponding to a user discriminated by said user discrimination means from said memory and executing the massage program according to the massage unit position parameter.

5. The massage machine as set forth in claim 3, wherein the parameter of the massage program includes an angle parameter concerning a reclining angle of the backrest, said memory storing a change of the angle parameter inputted by said parameter changing means for each user, said control means reading out the angle parameter corresponding to a user discriminated by said user discrimination means form said memory and deciding the reclining angle according to the angle parameter and executing the massage program.

6. The massage machine as set forth in claim 1, wherein said user discrimination means discriminates each user by at least one of a fingerprint and voice.
